(19) United States
(12) Patent Application Publication
(10) Pub. No.: US 2008/0174814 A1
(43) Pub. Date: Jul. 24, 2008

(54) Image processing apparatus and image processing system

(75) Inventor: Akiko Nagata, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/002,589

(22) Filed: Dec. 18, 2007

(30) Foreign Application Priority Data
Dec. 18, 2006 (JP) 2006-339542

(51) Int. Cl. G06F 3/12

(52) U.S. Cl. 358/1.15

(57) ABSTRACT

When execution of a job is stopped by an error or the like, and when an uncompleted job is generated, the stagnation of the job is eliminated by enabling a user different from a requesting user of the job to cope with the uncompleted job. The user different from the requesting user inputs identification information through a user information input section 8. When recognizing the identification information, a permitting section 24 permits the recognized user to perform an operation to cope with the uncompleted job. When the user selects the uncompleted job and performs an operation to notify the uncompleted job, the notifying section 21 creates a message to notify that there is an uncompleted job, and transmits the message to a terminal apparatus 2 of the requesting user. A treatment section 22 deletes the uncompleted job or puts the uncompleted job on standby according to a response from the requesting user, so as to eliminate the stagnation of the job.

### BACKGROUND OF THE INVENTION

1. Field of the Invention

The present invention relates to an image processing apparatus adapted to execute a job requested from a terminal apparatus of a user.

2. Description of the Related Art

An image processing apparatus which performs processing such as copying, printing, facsimile communication and data transmission, is communicably connected to terminal apparatuses such as a personal computer or the other image processing apparatuses through a network such as a LAN. An image processing system is formed by the plurality of image processing apparatuses and the plurality of terminal apparatuses.

A user creates image data by using the terminal apparatus. The user sets job information including processing information for performing desired processing to the image data, so that a job is generated. The terminal apparatus requests the execution of the job by transmitting the generated job to the image processing apparatus. The image processing apparatus executes the received job by performing requested processing such as printing to the job. When a plurality of jobs are requested, the image processing apparatus executes the job in the order of the receipt of the requests.

Then, as described in Japanese Patent Laid-Open No. 2004-157595, at the time of the execution of the job, the image processing apparatus notifies the terminal apparatus of the requesting user of the completion of the job or the interruption of the job by an e-mail. Thereby, it is possible for the requesting user to know the execution state of the job.

The image processing apparatus is used by a number of users. A user requests a job through a terminal apparatus, while the other user directly requests a job by operating the image processing apparatus. Here, when an error or a trouble such as paper exhaustion occurs during execution of the job requested from the terminal apparatus, the job is interrupted so that an uncompleted job is generated. The image processing apparatus notifies the terminal apparatus of the requesting user that the requested job is interrupted.

At this time, the presence of the uncompleted job causes the job to be stagnated. When the user who requested a subsequent job is waiting in front of the image processing apparatus, the user cannot freely take a measure against the uncompleted job. This prevents the waiting user from using the image processing apparatus, so that the image processing apparatus cannot execute the job waiting for execution.

Here, if it is possible for the waiting user to notify the requesting user that the requested job is not completed, the waiting user is capable of immediately coping with this situation in dependence upon a response from the requesting user. Thus, in view of the above, it is an object of the present invention to provide an image processing apparatus configured, when a job requested by a user is uncompleted, to enable a user different from the requesting user to notify the requesting user of the generation of the uncompleted job, to thereby facilitate efficient job execution.

### SUMMARY OF THE INVENTION

According to the present invention, an image processing apparatus configured to execute a job requested by a user includes: a notifying section configured, when execution of the job is interrupted and an uncompleted job is generated, to notify the execution state of the job to a terminal apparatus of the requesting user of the uncompleted job; and a permitting section configured to permit an operation to perform the notification.

In order to perform the notification, it is necessary to obtain permission from the permitting section. When the permission is obtained, an authorized user other than the requesting user is permitted to operate the image processing apparatus. The authorized user is permitted to immediately notify the requesting user of the presence of the uncompleted job. When there is a response from the requesting user, the authorized user is enabled to cope with the uncompleted job, and to thereby eliminate the stagnated job. On the other hand, without the permission, the user is unable to operate the image processing apparatus. Thus, it is possible to prevent the leakage of data by unauthorized use of the image processing apparatus and to thereby ensure the security.

The permitting section checks identification information input by the user. When able to recognize identification information of a user different from the requesting user, the permitting section permits the recognized user to perform the notification. When unable to recognize the identification information input by the user, the permitting section inhibits the unrecognized user from performing the notification. By performing authentication of the user, it is possible to prevent unauthorized use of the image processing apparatus. Note that the user directly inputs the identification information or inputs the identification information through the terminal apparatus of the user. The authorized user is permitted to operate the image processing apparatus directly or indirectly.

The notifying section generates a message according to an execution state of the job. On the basis of the message, it is possible for the requesting user to know the job execution state, such as an execution uncompleted state, an execution waiting state, and an execution completion state. Since the notifying section collectively performs the processing for creating the message to the processing for transmitting the message, it is possible for the user to save labor for creating the message.

When the execution of the job is not completed by an error, the notifying section notifies the error and transmits a message for inquiring about a measure to cope with the uncompleted job. The notification enables the requesting user to know the contents of the error. This makes it possible for the requesting user to select a suitable measure against the uncompleted job.

The image processing apparatus according to the present invention further includes a treatment section configured to cope with the uncompleted job. The treatment section performs, as a measure against the uncompleted job, one of treatment operations to delete the job, to put the job on standby, and to permit interruption of the other job. When the authorized user selects one of the treatment operations, the treatment section performs the selected treatment operation. This enables the stagnated job to be eliminated. Further, this enables the job waiting for execution to be executed.

The treatment section performs a treatment operation according to a response to the notification from the terminal apparatus. The requesting user is enabled to respond to the message and to return a response for instructing a desired treatment operation. According to the response, the processing section performs the instructed treatment operation to the uncompleted job. During this period, the user who performed the notification need not perform any operation. Note that when a message is included in the response from the terminal apparatus, the treatment section displays the message.

When there is no response from the terminal apparatus, the treatment section puts the uncompleted job on standby. When the requesting user does not return a response, and when the uncompleted job cannot be coped with, the job remains to be stagnated. Thus, by forcibly putting the uncompleted job on standby, it is possible to execute the job waiting for execution. On the other hand, since the uncompleted job is not deleted, it is possible for the requesting user to make the job re-executed at any subsequent time.

When the job remains on standby, the job is not executed. Thus, when there is a standby job, the treatment section performs, as a measure against the standby job, a treatment operation selected from treatment operations to execute the job, to delete the job, and to keep the job on standby. This enables the standby job to be eliminated.

At this time, the treatment section performs a treatment operation selected by a user whose identification information was able to be recognized. It is possible for the requesting user of the standby job to select a desired treatment operation. When the treatment operation to execute the standby job is selected, the uncompleted job is completed.

According to the present invention, by an operation of a user different from a requesting user, it is possible to notify the generation of an uncompleted job and to quickly cope with the stagnated job. Thereby, it is possible to shorten the period in which an image processing apparatus cannot be used, and to execute a job waiting for execution. As a result, it is possible to improve the job processing efficiency of the image processing apparatus.

### BRIEF DESCRIPTION OF THE DRAWINGS

FIG. 1 is a figure showing a schematic configuration of an image processing system and an image processing apparatus according to the present invention;

FIG. 2 is a flow chart in the case where a requested job is executed;

FIG. 3 is a flow chart in the case where when an uncompleted job is generated, the job is notified to a requesting user, so as to be deleted;

FIG. 4 is a figure showing a screen in which a job execution state is displayed;

FIG. 5 is a figure showing an operation screen at the time of notifying an uncompleted job;

FIG. 6 is a figure showing an example of user information;

FIG. 7 is a figure showing a message format at the time of notifying an error job;

FIG. 8 is a figure showing a message format at the time of notifying an uncompleted job other than the error job;

FIG. 9 is a flow chart at the time of putting a selected job on standby;

FIG. 10 is a figure showing an operation screen at the time of performing notification for putting a job on standby;

FIG. 11 is a flow chart at the time of putting an uncompleted job on standby;

FIG. 12 is a flow chart at the time of performing a treatment operation of the standby job; and

FIG. 13 is a figure showing an operation screen at the time of recognizing a user and selecting a treatment operation for the standby job.

### DETAILED DESCRIPTION OF THE PREFERRED EMBODIMENTS

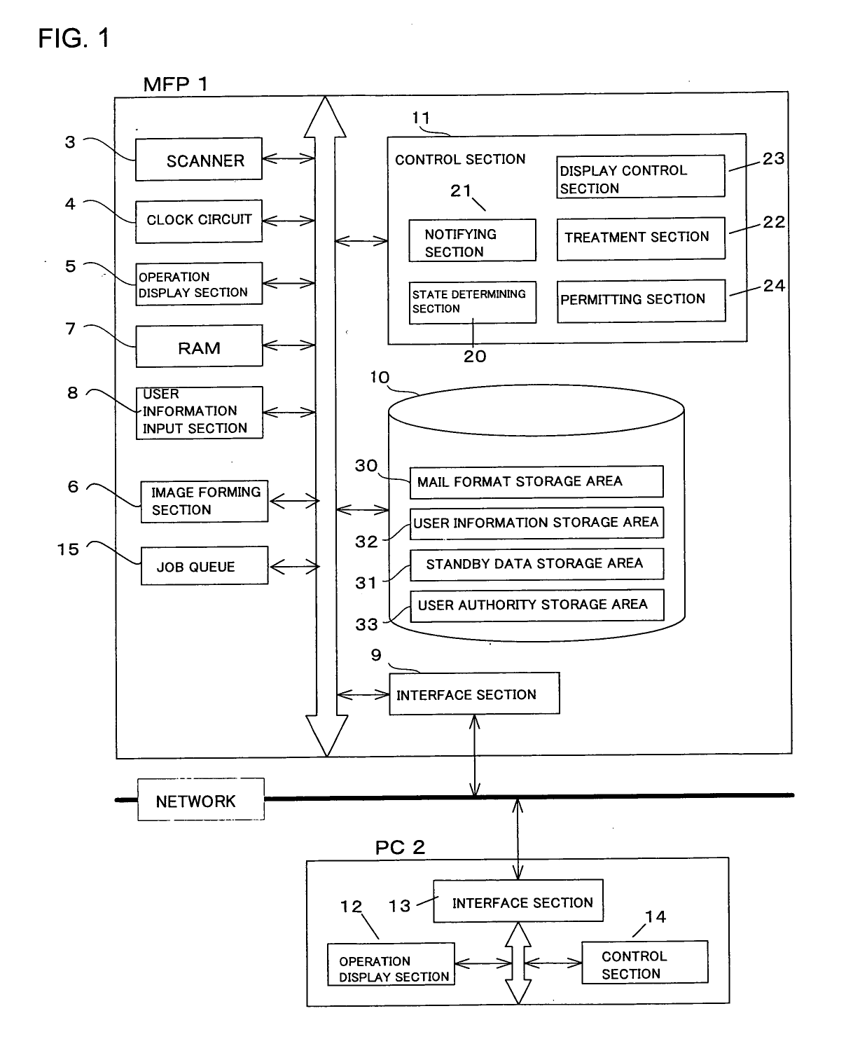

FIG. 1 shows an image processing system according to the present embodiment. The image processing system is configured by including an image processing apparatus 1 and a terminal apparatus 2, such as a personal computer and a server. The image processing apparatus 1 is communicably connected to the terminal apparatus 2 through a network, such as a LAN, a WAN, and the Internet. Note that the number of the image processing apparatus 1 and the terminal apparatus 2 is not limited to one, but may be plural.

The image processing apparatus 1 is an MFP configured to perform respective processing operations, such as copying, printing, scanning, and facsimile communication, and executes a job for performing an instructed processing operation to an input image data. The image processing apparatus 1 includes a scanner 3, a clock circuit 4, an operation display section 5, an image forming section 6, a memory 7, a user information input section 8, an interface section 9, a storage section 10, and a control section 11.

The scanner 3 reads a document and inputs image data. The image forming section 6 prints the image data subjected to image processing on a recording sheet. The clock circuit 4 has a clock and measures time. The operation display section 5 includes an operation section and a touch panel type display section, and receives an input based on an operation of a user. The memory 7 consists of a RAM and temporarily stores image data.

The user information input section 8 receives identification information of the user. The identification information is information for specifying the user, such as, for example, a user account, and biological information. The user information input section 8 is, for example, a card reader for an IC card, so as to read and input the user account from the IC card possessed by the user. Note that the user account may also be input through the operation section or input by communication from the terminal apparatus 2.

The interface section 9 is connected to the network, and performs transmission and reception of data to and from the control section 11, the terminal apparatus 2 and the other image processing apparatus 1 according to a predetermined communication protocol. The storage section 10 consists of a hard disk apparatus, and stores image data and various kinds of information. The control section 11 consists of a microcomputer and executes a job by controlling the respective sections according to a control program. Note that the image processing apparatus 1 includes a modem section which is connected to a telephone line so as to perform facsimile communication.

A personal computer used as the terminal apparatus 2 is a general type including an operation display section 12, an interface section 13 and a control section 14. The user uses the terminal apparatus 2, so that the terminal apparatus 2 creates image data by an application software, or acquires image data from the image processing apparatus 1 and the other terminal apparatus 2. The terminal apparatus 2 sets job information for the image data to generate a job. The terminal apparatus 2 transmits the image data and the job information to the image processing apparatus 1. In this way, the user requests a job to the image processing apparatus 1 by using the terminal apparatus 2. Note that the job information includes information about the requesting user. The information about the requesting user includes the identification information of the user, and the identification information of the terminal apparatuss 2 such as, for example, an IP address and a mail address.

The image processing apparatus 1 executes the requested job. The job is requested by a direct operation by the user, or requested from the terminal apparatus 2. The image processing apparatus 1 includes a job queue 15 to store the requested job. When a job is requested, the job queue 15 stores the image data and the job information by using a nonvolatile memory, such as a flash memory. The job is stored in the order of the receipt. Then, the control section 11 executes the job in the order of receipt. Note that the job queue 15 may store the job by using the storage section 10.

The image processing apparatus 1 monitors the execution of the requested job, and notifies the execution state of the job. That is, the control section 11 includes a state determining section 20 for determining the execution state of the job, a notifying section 21 for notifying the user of the execution state, and a treatment section 22 for, when the execution of the job is not completed, performing a treatment operation to cope with the uncompleted job. Further, the control section 11 includes a display control section 23 for driving and controlling the operation display section 5, and a permitting section 24 for judging the user identification information input from the user information input section 8 and determining whether or not to permit the operation.

The state determining section 20 determines that the requested job is in an execution waiting state, in a state during execution, in an execution completion state, or in an execution uncompleted state. The uncompleted job means an error job in an uncompleted state, such as a job interrupted by a trouble such as paper exhaustion and a paper jam, or a job stopped due to the generation of an error. Further, during execution of a job, when the processing time of the job is long, or when the processing enters a looping state, the job remains to be executed, and the other job cannot be executed. The job having such long processing time is handled as an uncompleted job.

The notifying section 21 transmits the execution state of the job to the terminal apparatus 2 by using an e-mail software and a browser. Further, the notifying section 21 receives a response to the notification from the terminal apparatus 2. Here, an e-mail is used for the notification. The notifying section 21 creates a message according to a predetermined format. The predetermined format is determined according to an execution state. Further, a format for notifying that the job is uncompleted is determined according to a kind of an error, or a reason for the interruption. Various kinds of formats are stored in a mail format storage area 30 of the storage section 10. The notifying section 21 automatically selects a suitable format from these formats on the basis of a determined execution state.

The treatment section 22 performs, as a measure against the uncompleted job, one of treatment operations to delete the job, to put the job on standby, to execute interrupt processing of the other job, and to re-execute the job. In the treatment operation to delete the job, the uncompleted job is deleted from the job queue 15. The deleted job is not executed. In the treatment operation to put the job on standby, the uncompleted job is transferred from the job queue 15 to the storage section 10, and stored in the storage section 10. A standby data storage area 31 for storing the standby job is provided in the storage section 10. The standby data storage area 31 is assigned for each user. In the treatment operation to execute the interrupt processing, the unexecuted job stored in the job queue 15 is executed. In the treatment operation to re-execute the job, the uncompleted job is re-executed.

The permitting section 24 checks the user or the terminal apparatus 2 by comparing the identification information of the user or the terminal apparatus 2 input from the user information input section 8 with the user information registered beforehand. The user information is stored in a user information storage area 32 of the storage section 10. The user information includes identification information such as an ID and a password, and a user name. Further, the user information includes history information such as the execution state of the requested job.

When the user or the terminal apparatus 2 is recognized by the permitting section 24, the user or the terminal apparatus 2 is permitted to log in to the image processing apparatus 1, and to perform operations to the image processing apparatus 1. When the user or the terminal apparatus 2 is not recognized by the permitting section 24, a part of the operations is restricted. Therefore, after being recognized by the permitting section 24, the user is permitted to perform special operations such as the operation to provide the notification and the operation to cope with the uncompleted job. When the user is not recognized, the user is inhibited from performing the special operations.

Further, a user authority storage area 33 for storing authority information about the authority of the user for the image processing apparatus 1 is provided in the storage section 10. The authority information includes the authority to provide notification or the authority to cope with an uncompleted job, and is set for each user in linkage with the above described user information. Therefore, the permitting section 24 checks the authority of the user and determines whether to permit or inhibit the special operation, according to the authority. When the user has the authority, the special operation is permitted. When the user does not have the authority, the special operation is inhibited.

When the execution of the job is stopped by an error or the like, during execution of the requested job, an uncompleted job is generated. At this time, the user who requested the execution of the job is notified that the requested job is not completed, by an operation of a user different user from the requesting user. Then, the other job is made executable by coping with the uncompleted job and eliminating the stagnated job. A series of the operations will be described below.

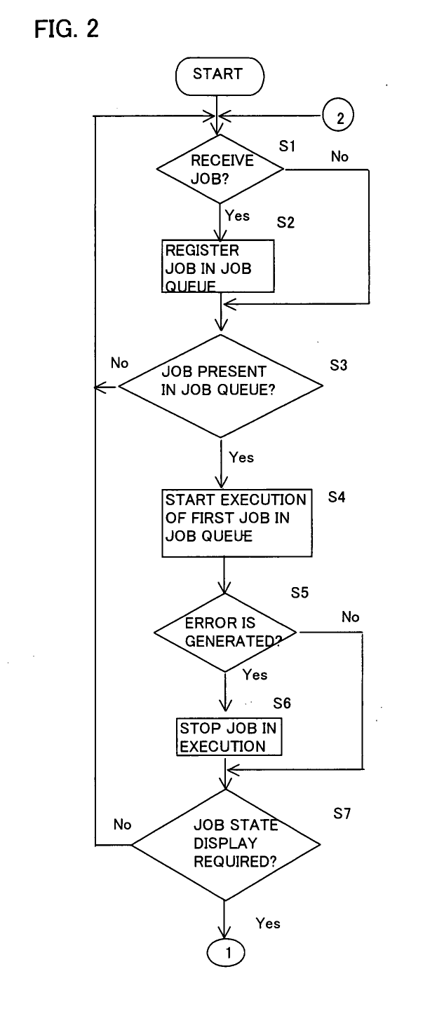

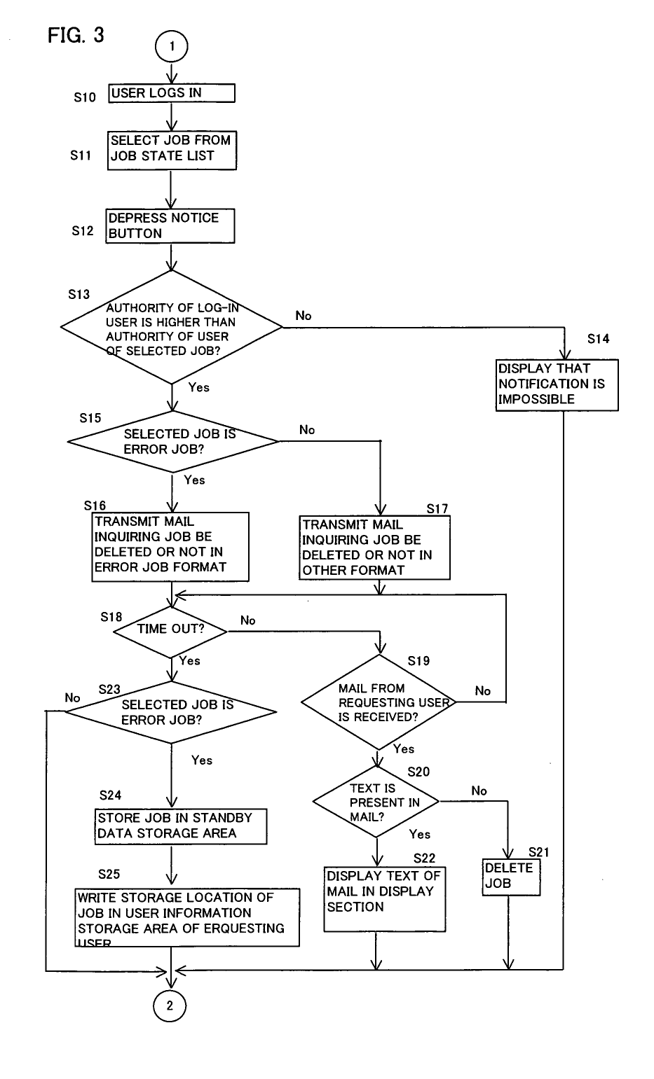

As shown in FIG. 2 and FIG. 3, when the image processing apparatus 1 receives a job from the terminal apparatus 2 (S1), the image processing apparatus 1 registers the job in the job queue 15 (S2). When the job is stored in the job queue 15 (S3), the control section 11 executes the job requested at first (S4). When an error or a trouble is generated during execution of the job (S5), the execution of the job is stopped (S6). When no abnormality such as an error is generated, the execution of the job is completed. The state determining section 20 monitors execution states of the respective jobs, such as an execution completion state, an execution uncompleted state, and an execution waiting state.

A user in front of the image processing apparatus 1 operates the image processing apparatus 1 to check the job (S7). Upon receipt of the request to check the job, the control section 11 displays a screen for inputting the identification information of the user. The user inputs the identification information through the user information input section 8. The permitting section 24 checks the input identification information.

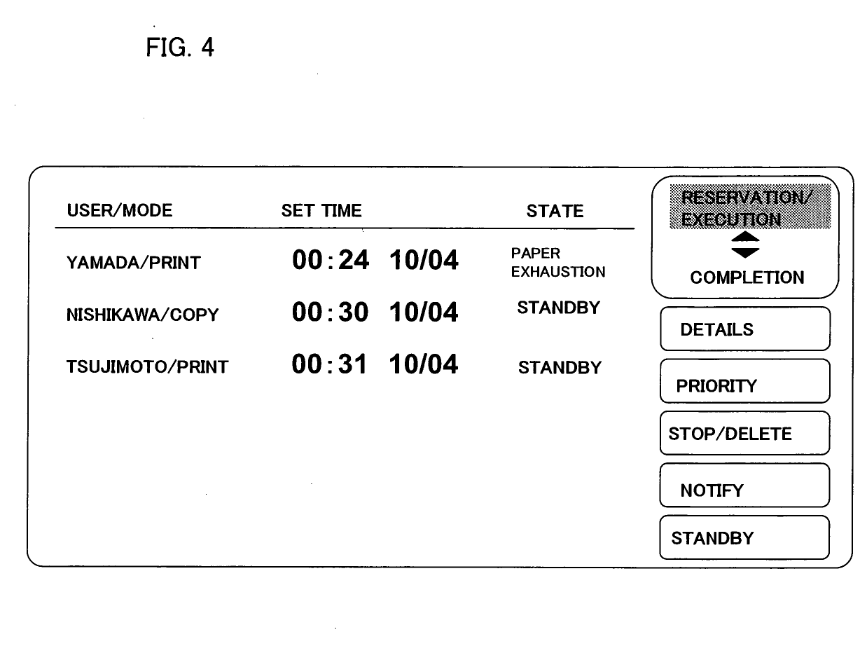

When the input identification information is recognized, the permitting section 24 permits the user to log in (S10). The control section 11 acquires the execution state of respective jobs from the state determining section 20, and drives a display section to display the execution state of the respective jobs. A list of the jobs as shown in FIG. 4 is displayed on the screen. For example, since paper exhaustion is generated during execution of the first job, the job is not completed. Note that when the user identification information is not recognized, the user cannot log in, and hence the above described list is not displayed.

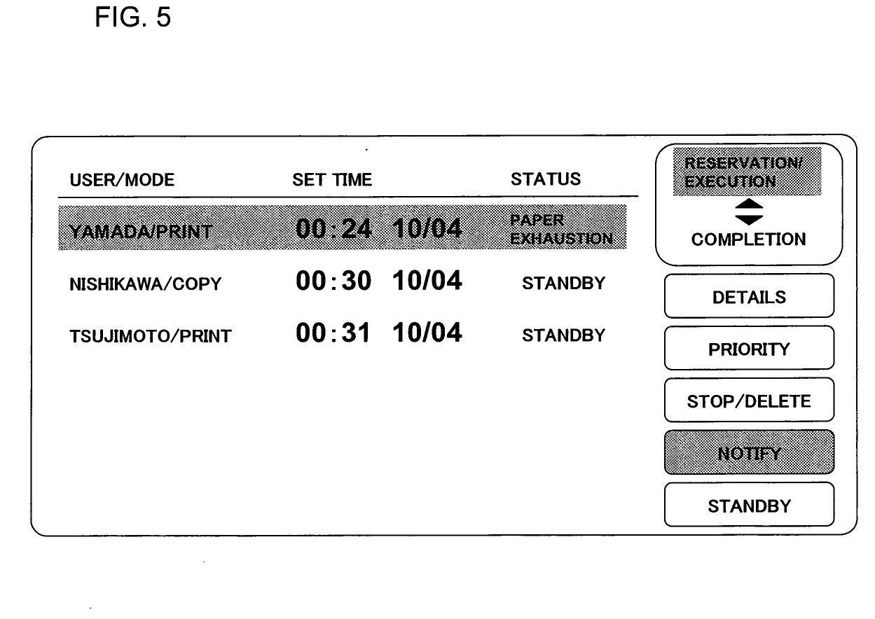

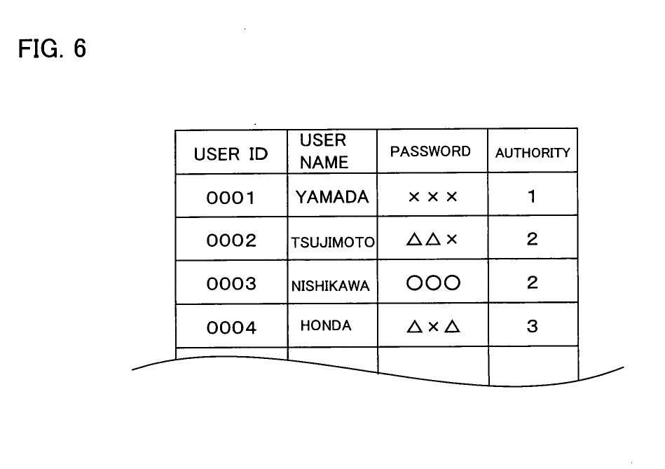

As shown in FIG. 5, in order to notify the requesting user, the user selects the uncompleted job from the display screen (S11) , and depresses a notice button (S12). At this time, the permitting section 24 checks the authority of the user who performed the operation. That is, the permitting section 24 compares the authority of the user who logged in with the authority of the requesting user, so as to determine the level of the authorities of the users. As shown in FIG. 6, the level of authority is set for each user in the user information.

When the level of the authority of the user who logged in is equal to or higher than the level of the authority of the requesting user, the permitting section 24 permits the user who logged in to provide the notification (S13). When the level of the authority of the user who logged in is lower than the level of the authority of the requesting user, the permitting section 24 inhibits the user who logged in from providing the notification. A message indicating that “notification impossible” is displayed in the display section (S14). The control section 11 logs out. In this way, only the authorized user is permitted to perform the special operation. Therefore, it is possible to inhibit a general user from performing an operation disadvantageous to the other users.

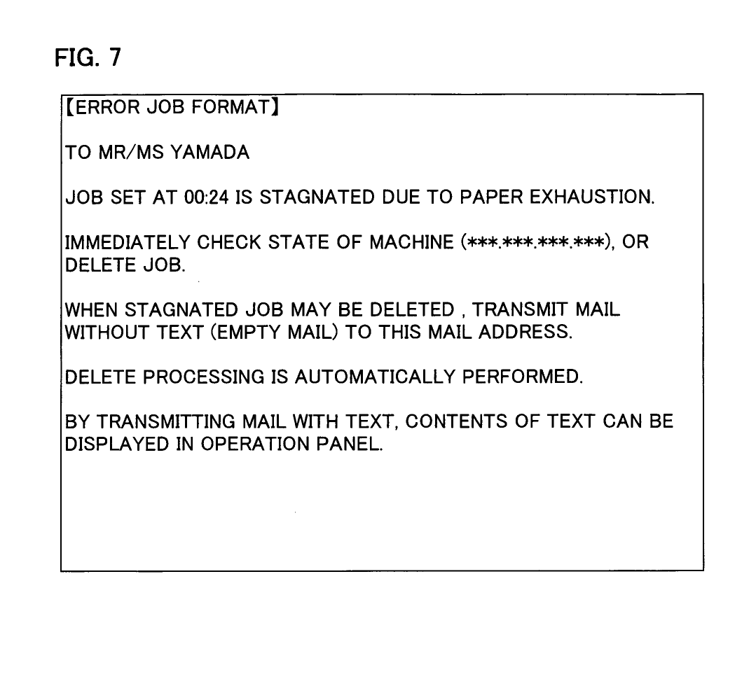

When providing the notification to the requesting user, the control section 11 checks the selected job (S15). When the selected job is an uncompleted job and an error job stopped by an error, a trouble or the like, the notifying section 21 selects a format corresponding to the error job, and creates a message to inquire about a measure to cope with the uncompleted job, such as a measure to delete the job. At this time, the notifying section 21 acquires a specific state of the error or the trouble from the state determining section 20, and describes the specific state in the message as shown in FIG. 7. Then, the notifying section 21 transmits an e-mail including the created message to the terminal apparatus 2 of the requesting user (S16).

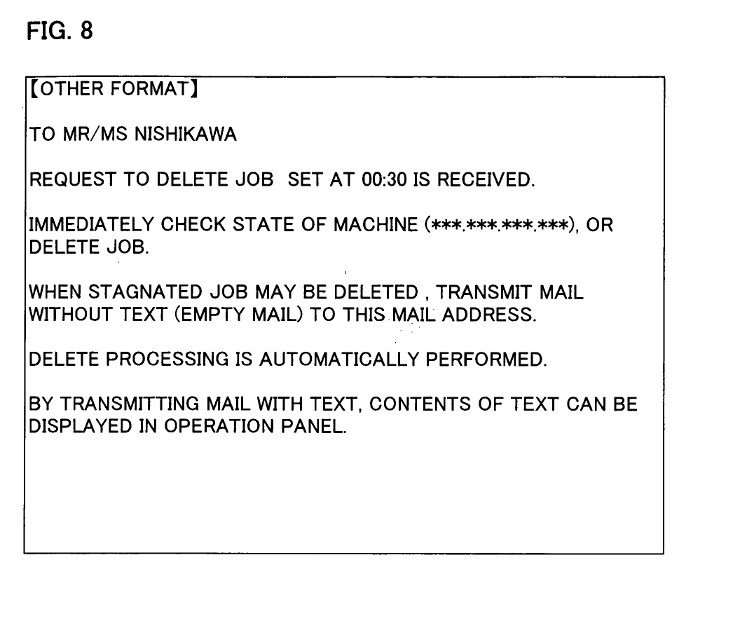

When the selected job is an uncompleted job but not an error job, that is, when the selected job is a job of long processing time, the notifying section 21 selects a format corresponding to the job of long processing time, and as shown in FIG. 8, similarly creates a message to inquire about a measure to cope with the uncompleted job, such as a measure to delete the job. Then, the notifying section 21 transmits an e-mail including the created message (S17).

The image processing apparatus 1 waits the e-mail from the terminal apparatus 2 for a predetermined period of time (S18). Upon receipt of the e-mail, the requesting user transmits a return mail as a response to the notification. Upon receipt of the return mail from the terminal apparatus 2 of the requesting user (S19), the notifying section 21 of the image processing apparatus 1 checks the message (S20). When the return mail is an empty mail, the treatment section 22 determines that the deletion of the job has been permitted by the requesting user, and automatically deletes the uncompleted job from the job queue 15 (S21).

When the main text of the return mail includes a message from the requesting user, the message is displayed in the display section (S22). The log-in user looks at the message and performs a treatment operation instructed from the requesting user. For example, when the requesting user instructs to put the job on standby instead of deleting the job, the log-in user makes the uncompleted job transferred to the standby data storage area 31 of the storage section 10. Note that instead of permitting the user to perform a manual operation, it may be configured such that the control section 11 analyzes the contents of the message and automatically performs the instructed treatment operation.

In the case where there is no return mail from the requesting user even after the lapse of a predetermined period of time from the time when the e-mail was transmitted to the requesting user by the image processing apparatus 1, the treatment section 22 checks that the selected uncompleted job is an error job (S23), and puts the uncompleted job on standby (S24). The uncompleted job is stored in the standby data storage area 31 of the storage section 10. Then, the treatment section 22 writes the storage location of the uncompleted job in the user information storage area 32 (S25). The storage location of the uncompleted job is added to the user information of the requesting user.

When the selected uncompleted job is not an error job and is, for example, a job of long processing time, the treatment section 22 performs neither the treatment to delete the job nor the processing to put the job on standby, and continues the current processing. When there is no response from the requesting user, and when a measure is automatically performed, the notifying section 21 notifies the requesting user that the job is put on standby, or is in the state during execution.

As described above, the stagnated job can be eliminated by deleting the uncompleted job or putting the uncompleted job on standby. This enables the other job to be executed. The control section 11 executes the job requested at first among the jobs waiting for execution. In this way, it is possible to quickly eliminate the stagnation of the job and to efficiently execute the job.

Note that the log-in user may perform an interrupt operation in which a job waiting for execution is selected and preferentially executed. Alternatively, the user may request a new job as an urgent job, and perform an interrupt operation to make the urgent job preferentially executed.

When the treatment to delete the job is set as a measure to cope with the uncompleted job, the notification to inquire about the treatment to delete the job is automatically performed by the operation of a user different from the requesting user. At this time, since the user needs only to perform a simple operation, it is possible to save labor for creating a message and to reduce the burden of the user.

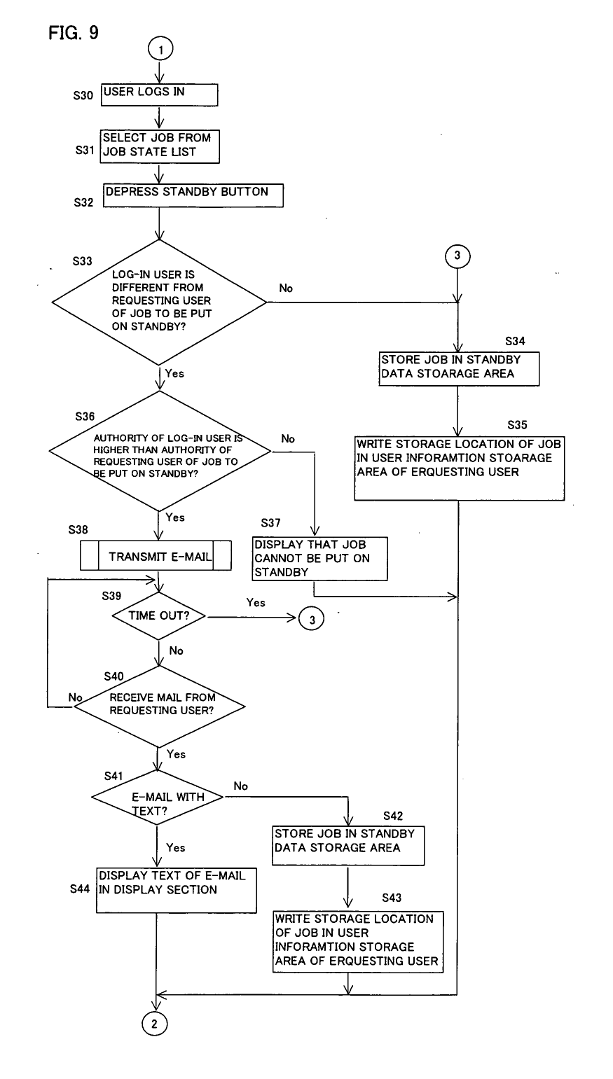

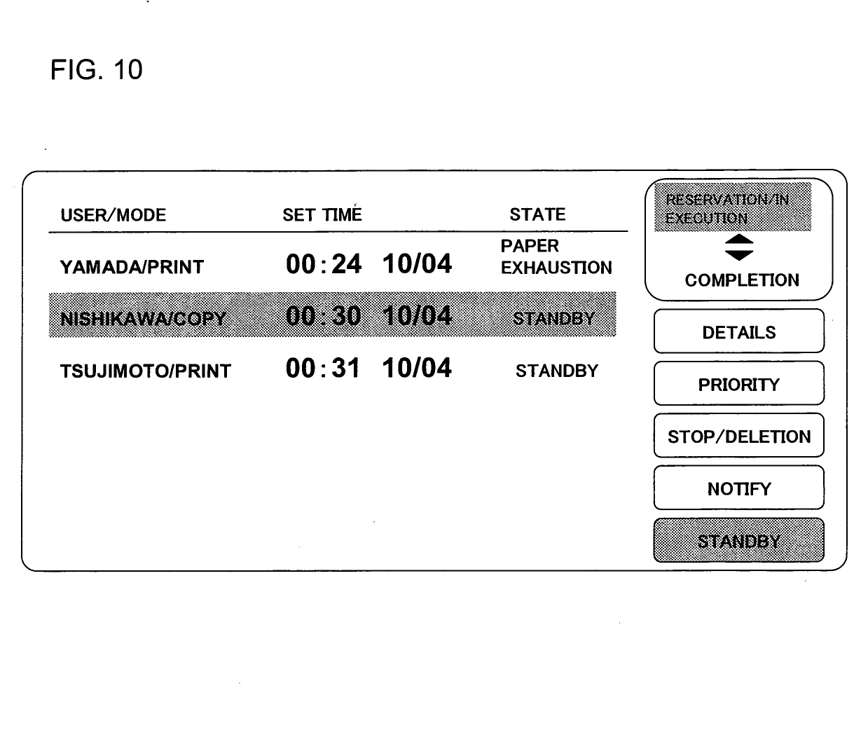

Meanwhile, it is possible for the user to select the other treatment in addition to the treatment to delete the job. FIG. 9 shows a series of operations in this case. After logging in (S30), the user selects a job desired to be put on standby in the display screen showing a list of execution states of jobs as shown in FIG. 10 (S31), and depresses a standby button (S32). Here, a job waiting for execution (during waiting) is selected.

The permitting section 24 first checks whether or not the log-in user is the same as the requesting user of the selected job (S33). When the log-in user is the requesting user, the user itself puts the job on standby. The processing section 22 stores the selected job in the standby data storage area 31 of the storage section 10 (S34). Then, the processing section 22 writes the storage location of the standby job in the user information storage area 32 (S35), and adds the storage location of the standby job to the user information of the requesting user.

When the log-in user is different from the requesting user, the permitting section 24 compares the authority of the log-in user with the authority of the requesting user of the selected job (S36). When the level of the authority of the log-in user is equal to or higher than the level of the authority of the requesting user, the permitting section 24 permits the notification that the treatment to put the job on stand by is to be performed. When the level of the authority of the log-in user is lower than the level of the authority of the requesting user, the permitting section 24 inhibits the notification. The message indicating that the treatment to put the job on standby cannot be performed, is displayed in the display section (S37). The control section 11 logs out.

The notifying section 21 selects a format corresponding to the treatment to put the job on standby, and creates a message to inquire about the treatment to put the job on standby. Then, the notifying section 21 transmits an e-mail including the created message to the terminal apparatus 2 of the requesting user (S38).

The image processing apparatus 1 waits for the e-mail from the terminal apparatus 2 for a predetermined period of time (S39). Upon receipt of the e-mail, the requesting user transmits a return mail as a response to the notification. When the notifying section 21 of the image processing apparatus 1 receives the e-mail from the terminal apparatus 2 of the requesting user (S40), the notifying section 21 checks the message (S41) . When the return mail is an empty mail, the treatment section 22 determines that the requesting user has permitted the job to be put on standby, and automatically stores the selected job in the standby data storage area 31 of the storage section 10 (S42). Then, the treatment section 22 writes the storage location of the standby job in the user information storage area 32 (S43). The storage location of the standby job is added to the user information of the requesting user.

When the text of the return mail includes a message from the requesting user, the message is displayed in the display section (S44). The log-in user looks at the message and performs the treatment operation instructed by the requesting user. For example, when the requesting user instructed the treatment to delete the job instead of the treatment to put the job on standby, the log-in user deletes the selected job. Note that instead of the user, the control section 11 may analyze the contents of the message and automatically perform the instructed treatment.

When there is no return mail from the requesting user even after the lapse of a predetermined period of time from the transmission of the e-mail by the image processing apparatus 1, the treatment section 22 forcibly puts the selected job on standby. The treatment section 22 writes the storage location of the job in the user information storage area 32, and adds the storage location of the standby job to the user information of the requesting user. In this case, the notifying section 21 notifies the requesting user that the job was put on standby.

As described above, after putting the job on standby, the control section 11 performs a job in the order of receipt among jobs waiting for execution. When there is an urgent job, the log-in user may select the job waiting for execution and preferentially make the selected job executed or may permit interruption of a new job so as to make the job executed.

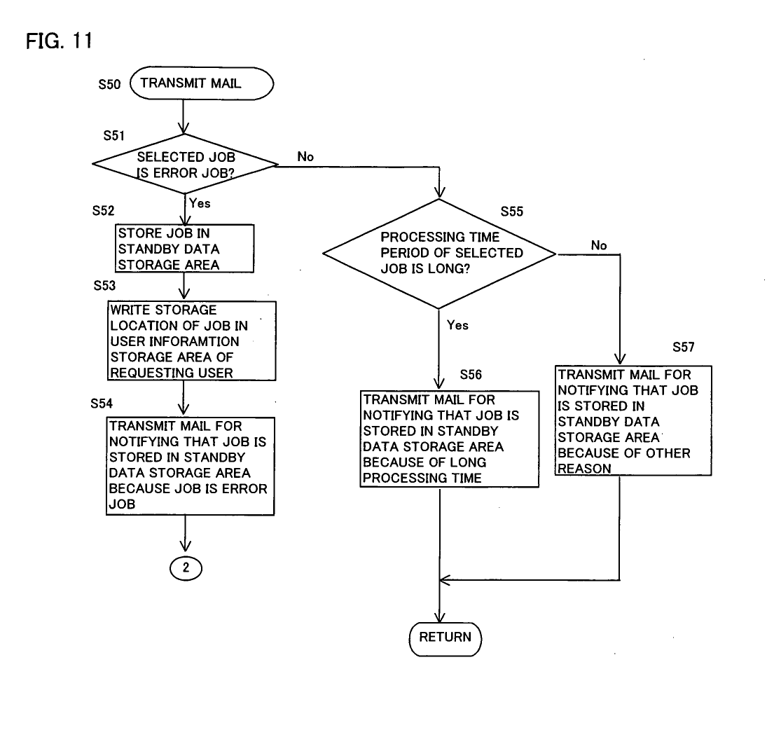

Further, when the log-in user desires to select an uncompleted job and to put the job on standby, as shown in FIG. 11, similarly to the above described case, an e-mail for notifying the requesting user that the uncompleted job is to be put on standby, is transmitted (S50).

When the selected uncompleted job is an error job (S51), the treatment section 22 puts the selected job on standby. The uncompleted job is stored in the standby data storage area 31 of the storage section 10 (S52). Then, the treatment section 22 writes the storage location of the uncompleted job in the user information storage area 32 (S53), and adds the storage location of the uncompleted job to the user information of the requesting user. Thereafter, the notifying section 21 creates a message to notify that the error job was put on standby, and transmits the message to the requesting user (S54). Then, the control section 11 executes the next job.

When the selected uncompleted job is not an error job (S51), the notifying section 21 transmits to the requesting user an e-mail for notifying the reason why the job is not completed, and for notifying that the uncompleted job is to be put on standby. For example, when the uncompleted job is a job of long processing time, the notifying section 21 creates a message for notifying that the job is to be put on standby because of long processing time of the job (S55, S56). When the job is not completed because of the other reason, the notifying section 21 creates a message for notifying the reason why the job is not completed, and for notifying that the job is to be put on standby, and transmits the message (S57).

A return mail is transmitted from the requesting user after the transmission of the e-mail. When the return mail is an empty mail, the treatment section 22 determines that the requesting user has permitted to put the selected job on standby, and stores the selected job in the storage section 10. Then, the treatment section writes the storage location of the standby job in the user information storage area 32, and adds the storage location of the standby job to the user information of the requesting user.

When there is no return mail from the requesting user, the treatment section 22 forcibly puts the selected job on standby. The treatment section 22 writes the storage location of the standby job in the user information storage area 32. In this case, the treatment section 22 notifies beforehand the requesting user that the job is to be put on standby, and hence does not perform the notification after the job was put on standby.

Next, the job is put on standby, and thereby the job remains unexecuted. Thus, it is configured such that the user is permitted to perform a treatment operation to deal with the job remaining unexecuted. That is, when there is a standby job, the treatment section 22 performs one of the treatment operations to execute the job, to delete the job, and to keep the job put on standby. The user is permitted to select one of the treatment operations.

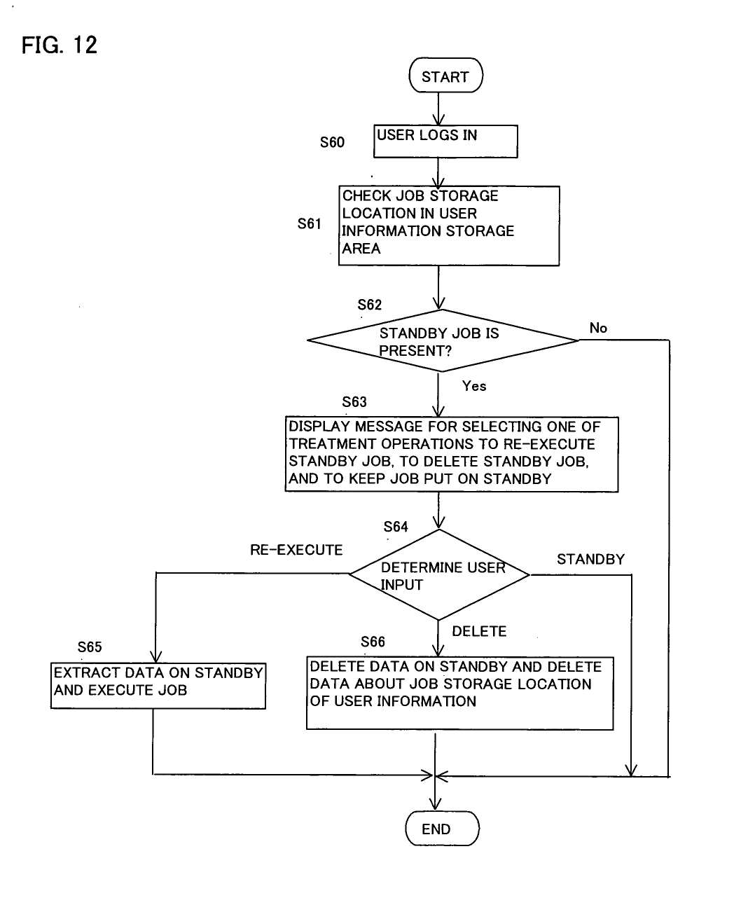

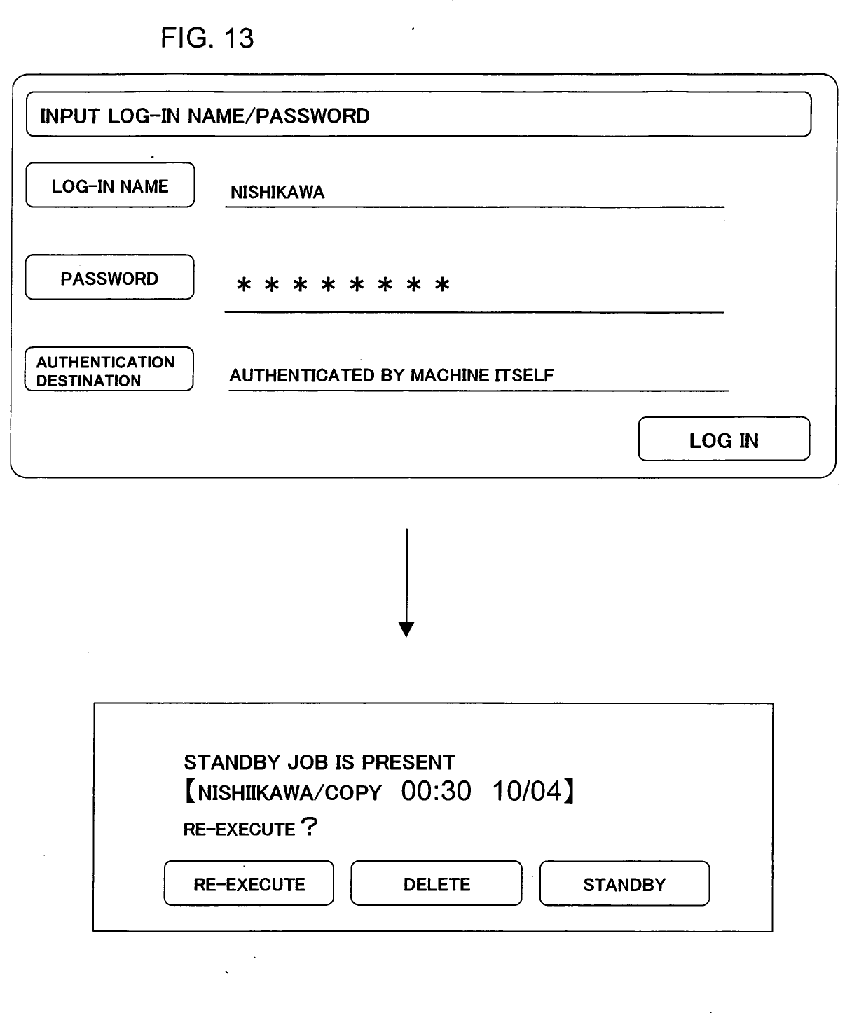

As shown in FIG. 12, after logging in (S60), the user checks whether or not a standby job is present. That is, as shown in FIG. 13, when the user is recognized by inputting the identification information thereof, the user is permitted to log in. When the user perform an operation to call the job, the control section 11 reads the user information of the log-in user, and checks the storage location of the standby job (S61). When the standby job is present (S62), the control section 11 displays a list of the standby job (S63). At this time, the screen for selecting one of the three treatment operations is displayed.

When the user selects one of the treatment operations to execute the job, to delete the job, and to keep the job put on standby, the treatment section 22 performs the selected treatment operation to the job (S64). When a plurality of standby jobs are present, the treatment is performed to one job selected by the user.

When the treatment to re-execute the job is selected, the treatment section 22 transfers the job to the job queue 15, and executes the job (S65). When the treatment to delete the job is selected, the treatment section 22 deletes the job. Then, the treatment section 22 also deletes the information about the standby job in the user information (S66). When the treatment to keep the job put on standby is selected, the treatment section 22 stores the job as it is in the storage section 10.

The log-in user does not have the authority to perform the treatment operation to the standby job of the other user. However, the user who has the highest authority like a manager, is capable of performing the treatment operation to the standby job of the other user. Therefore, the user who has the highest authority, is capable of deleting or re-executing the remaining standby job.

Further, the remaining standby job may be automatically deleted. The control section 11 stores the date and time when the job was put on standby, in a period management table, and manages the storage period of the standby job. The control section 11 automatically deletes the job, when a predetermined period of time is elapsed. When deleting the job, the notifying section 21 notifies the requesting user that the job is to be deleted. By confirming the user before the job is deleted, it is possible to prevent a necessary job from being deleted. In this way, by deleting the job remaining unexecuted, it is possible to reduce unnecessary consumption of the memory capacity.

Note that it is obvious that the present invention is not limited to the above described embodiment, and various modification and changes may be applied to the above described embodiment within the scope of the present invention. The notifying section provides notification to the terminal apparatus of the requesting user. However, as the terminal apparatus, other than the personal computer, a portable terminal apparatus carried by the user, such as a portable telephone and a PDA, may also be used. The image processing apparatus and the portable terminal apparatus are communicably connected to each other through the Internet, and the image processing apparatus provides notification to the portable terminal apparatus. At this time, the image processing apparatus preferably performs notification to both the portable terminal apparatus and the terminal apparatus. This enables the user to receive the notification, wherever the user is.

Instead of transmitting the e-mail, the notifying section may access the terminal apparatus and the portable terminal apparatus by using a browser, so as to transmit and receive information to and from the apparatuses. It is possible for the image processing apparatus to bi-directionally communicate with the terminal apparatus, and to thereby quickly cope with an uncompleted job.

It is possible for the user to access the image processing apparatus by using the terminal apparatus and the portable terminal apparatus. Thus, a user different from the requesting user may provide notification and perform a treatment operation through the terminal apparatus or the portable terminal apparatus. The user inputs the identification information thereof into the terminal apparatus, and the terminal apparatus transmits the identification information to the image processing apparatus. When the input identification information is recognized by the permitting section of the image processing apparatus, the user is permitted to log in. Therefore, even if the user is not in front of the image processing apparatus, the user is capable of coping with an uncompleted job through the terminal apparatus.

When the treatment of the uncompleted job is completed, the notifying section notifies the log-in user that the stagnated job was eliminated. This enables the user to immediately request a new job. Even if the user is not present in front of the image processing apparatus, it is possible for the user to recognize that the image processing apparatus is made available. Therefore, when there is an urgent copy job, it is possible for the user to immediately use the image processing apparatus.

What is claimed is:

1. An image processing apparatus configured to execute a job requested by a user, comprising: a notifying section configured, when execution of the job is stopped and an uncompleted job is generated, to notify the execution state of the job to a terminal apparatus of a requesting user of the uncompleted job; and a permitting section configured to permit an operation for providing the notification.

2. The image processing apparatus according to claim 1, wherein by checking identification information input by a user different from the requesting user, the permitting section permits the notification when recognizes the identification information of the user, and inhibits the notification when not recognize the identification information.

3. The image processing apparatus according to one of claim 1 and claim 2, wherein the notifying section generates a message according to an execution state of the job.

4. The image processing apparatus according to claim 3, wherein when execution of the job is not completed by an error, the notifying section transmits an error notification message to inquire about a measure to cope with the uncompleted job.

5. The image processing apparatus according to one of claim 1 and claim 2, further comprising a treatment section configured to cope with the uncompleted job, wherein the treatment section performs as a measure to cope with the uncompleted job, one of treatment operations to delete the job, to keep the job on standby, and to permit interruption by the other job.

6. The image processing apparatus according to claim 5, wherein the treatment section performs a treatment operation according to a response from the terminal apparatus to the notification.

7. The image processing apparatus according to claim 6, wherein when a message is included in the response from the terminal apparatus, the treatment section displays the message.

8. The image processing apparatus according to claim 6, wherein when there is no response from the terminal apparatus, the treatment section keeps the uncompleted job on standby.

9. The image processing apparatus according to claim 5, wherein when there is a standby job, the treatment section performs, as a measure to cope with the standby job, a treatment operation selected from treatment operations to execute the job, to delete the job, and to keep the job on standby.

10. The image processing apparatus according to claim 9, wherein the permitting section checks identification information input by a user, and the treatment section performs a treatment operation selected by the user whose identification information is recognized.

11. An image processing system, wherein an image processing apparatus configured to execute a job requested by a user is communicably connected to a terminal apparatus of the requesting user of the job, wherein the image processing apparatus comprises a notifying section configured to notify an execution state of the job to the terminal apparatus of the requesting user of the job, and a permitting section configured to permit an operation for providing the notification, and wherein when execution of the job is not completed and the notifying operation is permitted, the notifying section notifies the execution state of the job to the terminal apparatus of the requesting user.

12. The image processing system according to claim 11, wherein by checking identification information input by a user different from the requesting user, the permitting section of the image processing apparatus permits the notification when recognizes the identification information of the user, and inhibits the notification when not recognize the identification information.
